(19) United States
(12) Patent Application Publication
(10) Pub. No.: US 2003/0029916 A1
(43) Pub. Date: Feb. 13, 2003

(54) Apparatus and process for simultaneously handling a plurality of symbology encoded articles

(76) Inventors: John Merva, Weare, NH (US); William B. Bouvier, New Boston, NH (US); Brian Thompson, Deering, NH (US); Stephen M. Twaddle, Hudson, NH (US)

Correspondence Address: MORRIS I. POLLACK, 19 Eberhardt Road, East Hanover, NJ, 07936, US

(21) Appl. No.: 09/927,187

(22) Filed: Aug. 10, 2001

(51) Int. Cl. G06K 7/10; G06K 7/14

(52) U.S. Cl. 235/454

(57) ABSTRACT

An apparatus, system and process for simultaneously imaging a number of articles, each of which has applied thereto a unique encoded symbology distinguishing each article from every other article in the number of articles. The symbology encoding for all the articles, in an array of such articles, is simultaneously illuminated and imaged by one or more CCD type cameras. The resulting images of the array of encoded symbologies is thereafter assembled and decoded. The symbology encoded articles may, for example, be test tubes disposed in a rack and the CCD imaging may be effected by four cameras which are disposed to image the array of such symbologies.

### BACKGROUND OF THE INVENTION

1. Field of Application

This invention relates to apparatus and processes for handling of a plurality of encoded articles; and, more particularly to the simultaneous handling of symbology encoded articles.

2. Description of the Prior Art

It is quite often necessary to handle or process a plurality of similar, but in some ways different, articles. To process articles serially, that is one after the other, is conventional and common; but time consuming and costly. Apparatus is, accordingly, available to gather a plurality of articles together, in an array, in a rack, tray, or carrier and to then handle the articles in the array, individually, serially, or possibly all at once, depending upon the process and how the articles are to be processed. One example of handling an array of articles, in this instance, test tubes for immunochemical determinations, is shown and described in U.S. Pat. No. 4,284,603 patented on Aug. 18, 1981 to G. K. Korom for “Test Tube Decanter Rack”. However, while the articles in this instance, test tubes, are in a 5 by 12 array for processing there is no provision for correlating and tracking the individual test tubes and the tests to be performed on the substance(s) in the test tubes.

G. P. Kalmakis, et al, on the other hand, in U.S. Pat. No. 6,171,554, patented on Jan. 9, 2001, for “Apparatus And Method For Alphanumerically Identifying And Arranging Test Tubes” alphanumerically marks the test tubes to correspond to respective positions in the wells of a rack for a conventionally arranged 8 by 12 test tube array. Reading of the test tube identification, however, appears to require human intervention to either remove and read individual test tube identification or to lift the entire rack to do so. Once filled with the substance to be processed such handling of the test tubes may create difficulties and removal of the test tubes from the array may result in their return to incorrect well locations and improper processing.

Apparatus and systems for automated processing of articles, such as cuvettes, specimen carriers, and test tube cassettes are shown respectively in U.S. Pat. No. 5,098,661, patented on Mar. 24, 1992, to J. A. Froehlich for “Coded Cuvette For Use In Testing Apparatus” (utilizing multiple optical facets); U.S. Pat. No. 5,427,743, patented on Jun. 27, 1995 to R. S. Markin, for “Specimen Carrier” (utilizing bar coded strips); and U.S. Pat. No. 5,009,316, patented on Apr. 23, 1991, to D. C. Klein for “Test Tube Cassette System And Cassettes For Use Therein”. However, even though encoded for automated decoding of the identification and processing, the various articles are decoded individually and/or the article carriers (such as those of R. S. Markin and D. C. Klein are encoded and not the individual articles (test tubes) to be carried by the article carriers. The constructions of the respective article carriers are not capable of permitting individual symbology encoded articles to be read and decoded. The respective articles, (test tubes, etc.) if removed from the carrier foe processing, may also be replaced in incorrect positions in their respective carriers.

U.S. Pat. No. 5,357,095, patented on Oct. 18, 1994 to B. Wevrauch, et al, for “Reagent Bottle Identification And Reagent Monitoring System For A Chemical Analyzer” and U.S. Pat. No. 5,397,709, patented on Mar. 14, 1995, to K. W. Berndt for “System For Detecting Bacterial Growth In A Plurality Of Culture Vials” each utilize encoded symbology on the underside of the articles (reagent bottles and vials respectively). Reading of the symbology is, however, accomplished serially one article at a time by a single CCD type camera. Such a process is time consuming and inefficient.

### SUMMARY OF THE INVENTION

It is therefore an object of this invention to provide new and novel apparatus to read encoded symbology carried by a plurality of symbology encoded articles.

It is another object of this invention to provide new and novel methods to capture encoded symbology carried by a plurality of symbology encoded articles.

It is yet another object of this invention to provide new and novel apparatus to simultaneously read encoded symbology carried by a plurality of symbology encoded articles.

It is still another object of this invention to provide new and novel methods to simultaneously capture encoded symbology from a plurality of symbology encoded articles.

It is yet still a further object of this invention to provide new and novel apparatus and methods utilizing a plurality of symbology reading devices to read encoded symbology carried by a plurality of symbology encoded articles.

It is yet still a further object of this invention to provide new and novel apparatus and methods utilizing a plurality of symbology reading devices, each reading encoded symbology from a selected portion of a plurality of symbology encoded articles.

It is still further an object of this invention to provide new and novel apparatus to read encoded symbology carried by a plurality of symbology encoded vials.

It is yet still another object of this invention to provide new and novel methods to capture encoded symbology carried by a plurality of symbology encoded vials.

It is yet still a further object of this invention to provide new and novel apparatus to simultaneously read encoded symbology carried by plurality of symbology encoded vials arranged in an array.

It is yet still a further object of this invention to provide new and novel methods to simultaneously capture encoded symbology from a plurality of symbology encoded test tube vials arranged in an array in a rack.

It is yet still a further object of this invention to provide new and novel apparatus and methods utilizing a plurality of symbology reading devices to simultaneously read encoded symbology carried by a plurality of symbology encoded articles.

It is yet still a further object of this invention to provide new and novel apparatus and methods utilizing a plurality of symbology reading devices, simultaneously operated but so that each reads encoded symbology from a selected portion of a plurality of symbology encoded articles.

It is yet still a further object of this invention to provide new and novel apparatus and methods utilizing a plurality of symbology reading devices to simultaneously read encoded symbology carried by a plurality of symbology encoded vials, test tubes and the like.

It is yet still a further object of this invention to provide new and novel apparatus and methods utilizing a plurality of symbology reading devices simultaneously operated but so that each reads encoded symbology from a selected portion of a plurality of symbology encoded vials, test tubes and the like.

It is yet still a further object of this invention to provide new and novel apparatus and methods utilizing a plurality of symbology reading devices to simultaneously read encoded symbology carried by a plurality of symbology encoded vials, test tubes and the like arranged in an array.

It is yet still a further object of this invention to provide new and novel apparatus and methods utilizing a plurality of symbology reading devices to simultaneously each read encoded symbology from a selected portion of a plurality of symbology encoded vials, test tubes and the like arranged in an array carried by a rack on a tray.

It is yet still another further object of this invention to provide new and novel symbology decoding apparatus and methods to correlate encoded symbology carried by respective articles, such as vials, test tubes and the like, read by a plurality of reading devices simultaneously operated but so that each reads a selected portion of the encoded symbology from a selected portion of the symbology encoded articles.

It is yet still an even further object of this invention to provide new and novel automated apparatus and systems to individually encode each one of a plurality of articles, simultaneously read selected portions of such encoded symbology carried by selected portions of articles from a larger array of such articles when carried by an article carrier and to provide an output for utilization by a system processing such articles.

Other objects, features and advantages of the invention, in its details of construction, arrangement of parts and methods of operation, will be seen from the above and from the following detailed descriptions of the preferred embodiments when considered in conjunction with the accompanying drawings and the appended claims.

### BRIEF DESCRIPTION OF THE DRAWINGS

In the drawing:

FIG. 1. is a perspective view of an upper portion of an encoded symbology reader incorporating the instant invention for simultaneously reading the encoded symbology from each one of a plurality of articles (vials) arranged in an array in a rack for such vials;

FIG. 2. is a perspective view of the symbology reader of FIG. 1, somewhat reduced in size from that of FIG. 1, and showing the rack of articles removed from atop the symbology reader and with the rack support window removed to better show mechanisms internal to the reader;

FIG. 3. is a perspective view of an array of articles, in the form of vials, arranged in a rack and with the rack cover removed to better show details of the vials;

FIG. 4. is a perspective view of the symbology reader of FIG. 1 with the rack of vials and housing removed to better show details of the internal mechanisms;

FIG. 5. is a plan view of the symbology reader of FIG. 4;

FIG. 6. is a front elevation view of the reader of FIGS. 1 and 4 with a rack for articles (such as the rack and vials of FIG. 3), shown in phantom, positioned thereon;

FIG. 7. is a left side elevation view of the symbology reader of FIG. 5;

FIG. 8. is a perspective view of the symbology reader of FIG. 2;

FIG. 9. is a plan view of the symbology reader of FIG. 8;

FIG. 10. is a block diagram incorporating the instant invention for the described symbology reader and process.

FIG. 11. is a flow diagram of the process; incorporating the instant invention, for the described symbology reader; and

FIG. 12. is a view of the monitor display for the described symbology reader operations process;

### DETAILED DESCRIPTION OF THE PREFERRED EMBODIMENTS

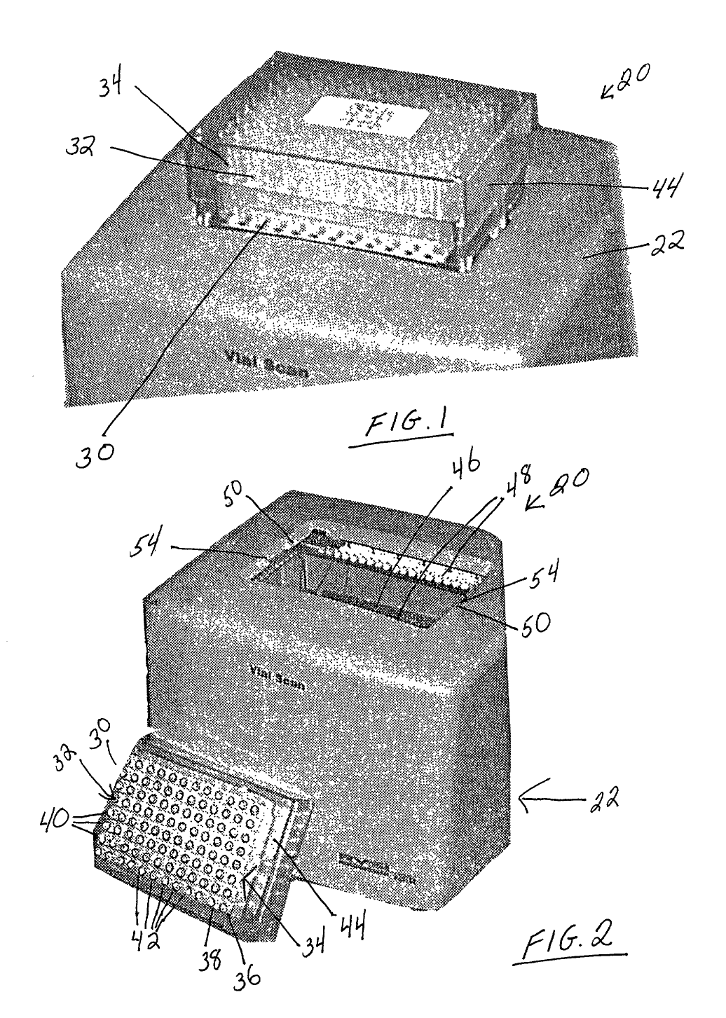

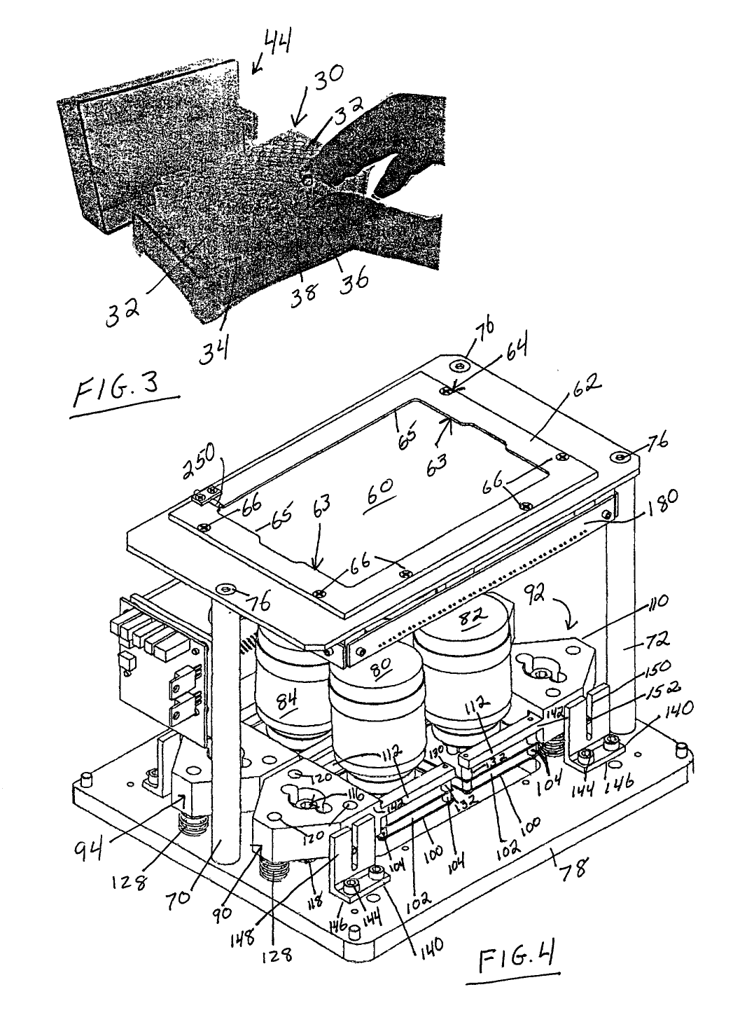

With reference to FIGS. 1 and 2 there is generally shown at 20 an encoded symbology scanner, incorporating the instant invention, with the mechanisms thereof arranged with a housing 22. Scanner 20 is to be associated with peripherals, to be hereinafter described, which together with scanner 20 comprise an encoded symbology reader 24.

A rack 30 (FIGS. 1-3) of symbology encoded articles, in this instance vials or test tubes 32, is shown in FIG. 1 disposed in symbology sensing position on top of scanner 20 (FIG. 1), adjacent scanner 20 (FIG. 2) and all by itself (FIG. 3). Vials 32 are shown disposed in rack 30 in an array 34 of 8 rows 40 and 12 columns 42. A cover 44 (FIGS. 1-3) is provided for vials 32 so that they may be covered to protect not only vials 32 while in array 34, but any contents (not shown) therein.

Each article, test tube, vial 32 and the like, carries, on an under or bottom surface 36 (FIGS. 2 and 3) thereof on encoded symbology 38. In this instance such encoded symbology 38 is the conventionally available “DATA MATRIX”. Each such encoded symbology may merely encode an identification, such as a number or the like, peculiar to the respective vial; with the numbers of the array 34 following serially and consecutively for each vial 32 in rack 30. Encoded symbology 38 may also include other information such as the characteristics of the substance in the respective vial 32, or to be thereinafter placed in each respective vial 32.

Encoded symbology 38 may be applied to each vial 32 by conventionally available equipment and systems to do so, as by printing, etching or the like.

An opening 46 (FIG. 2) with chamfered edges 48, 50 is formed through a top 52 of scanner housing 22. A notch 54 is formed in each edge 48 to facilitate removal of rack 30 from its position within opening 46 and on top of a tempered glass window 60 (FIGS. 4, 5, 6 and 7) which is positioned just below window opening 46. Window 60 not only forms a seat for rack 30, but also serves to close off opening 46 into housing 22 to protect the contents thereof from dust, dirt and damage. Window 60 is made from tempered glass, but other materials, such as a suitable clear plastic may be utilized.

A window retainer 62, secured to a support plate 64 by suitable securing members such as threaded members 66 (FIG. 4), positions and retains window 60 in the above-described position. Window retainer 62 includes an opening 63 for window 60 and is formed with a recess 65 around the peripheral edges of opening 63 and up from a bottom surface of retainer 62 to hold window 60 in place.

A number of spacers 68 (FIGS. 6 and 7) may be utilized between window retainer 62 and support plate 58 and, if so, held in place by threaded members 66. Support plate 64 is, in turn, positioned and secured on top of support rods 70 (FIGS. 4 and 7), 72 and 74 (FIG. 7) as by threaded members 76 (FIGS. 4 and 5). Lower ends of support rods 70, 72 and 74 are, in turn, secured to a base plate 78 (FIGS. 4-9) by threaded members (not shown).

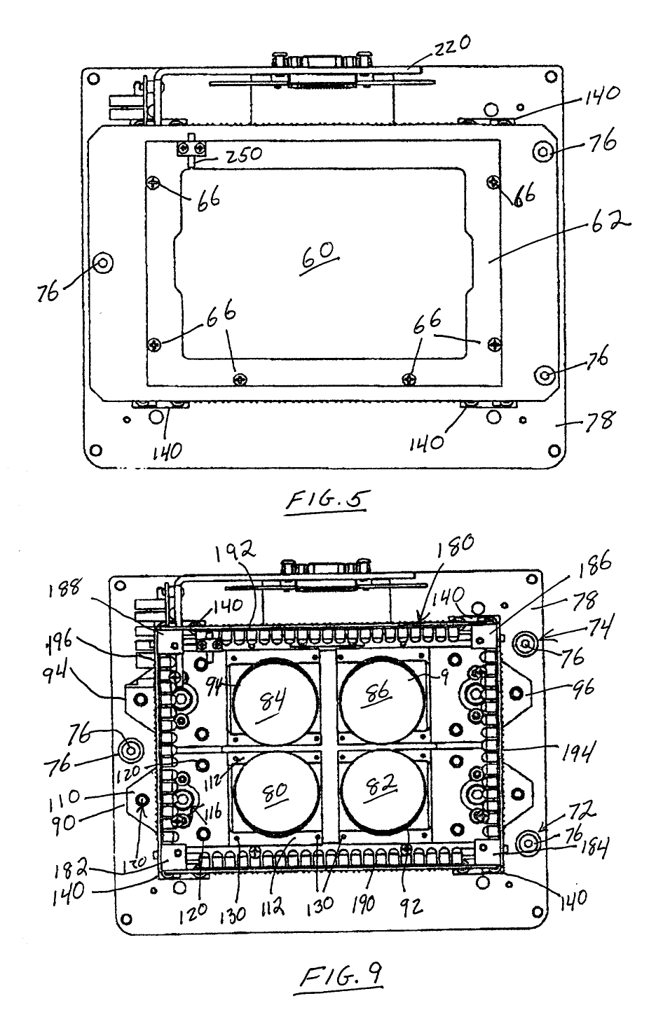

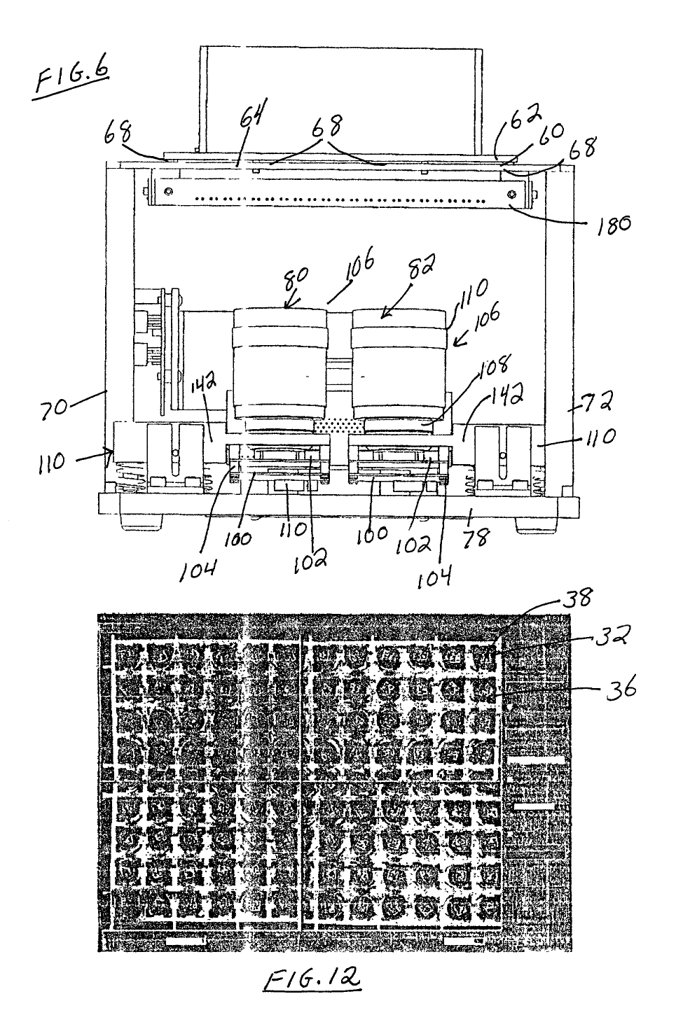

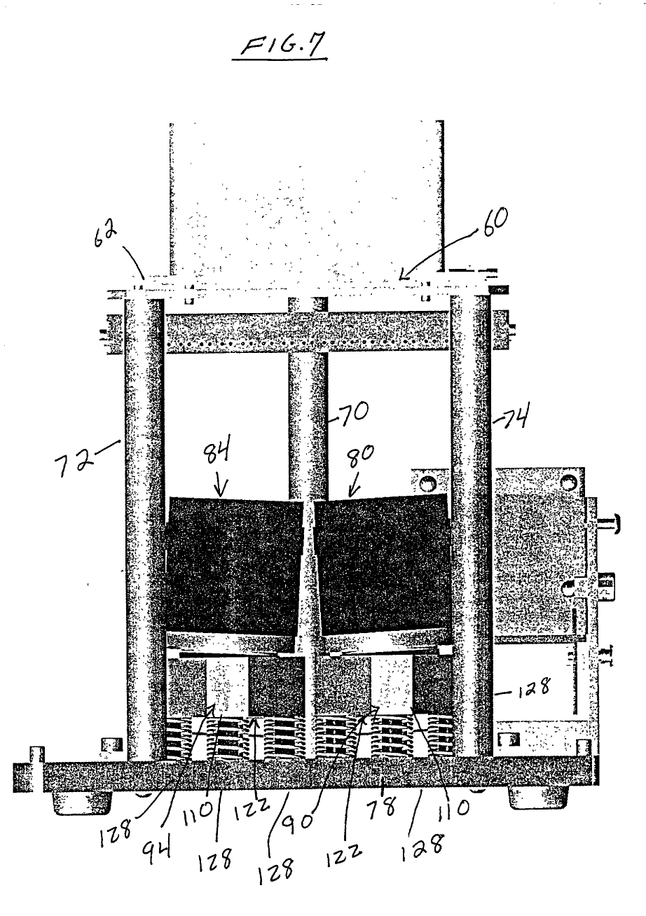

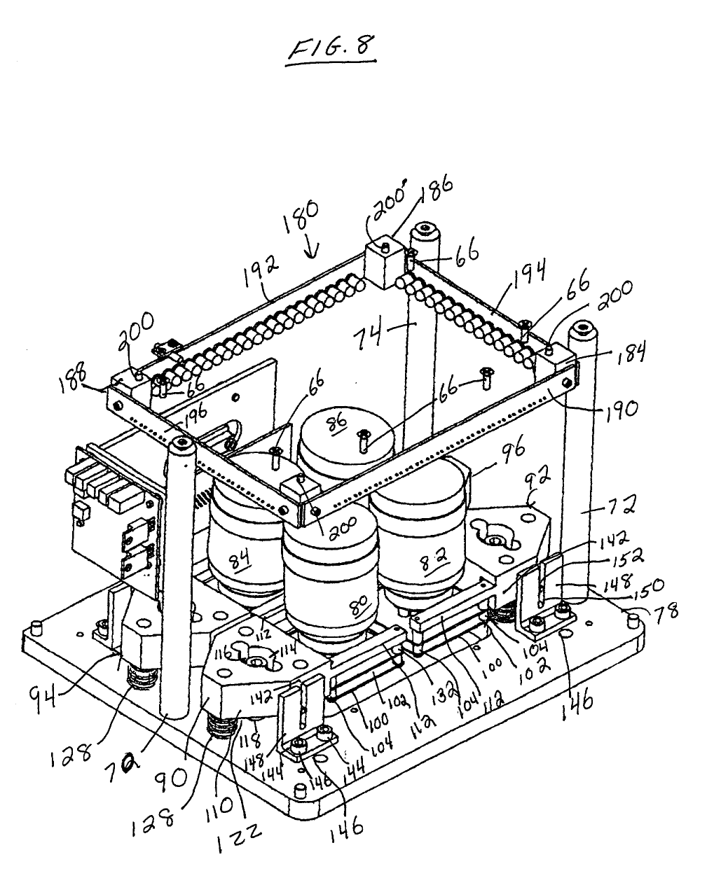

Four CCD camera assemblies 80 (FIGS. 8 and 9), 82, 84 and 86 respectively are supported within housing 22 each by its own camera support bracket assembly 90, 92, 94 and 96 respectively. Cameras 80-86 may be of conventional construction and may be ones such as those provided by Sensor Technologies America under their model number STC-170. Each camera assembly 80, 82, 84 and 86 includes a pair of printed circuit boards 100 (FIGS. 6 and 8) and 102 respectively attached together by suitable members (not shown) and separated from each other by spacers 104. Camera printed circuit boards 102,104 are secured to each camera 80, 82, 84 and 86 respectively in a suitable and appropriate manner, function for each respective camera in a conventional manner to operate same and facilitate operation thereof and to connect the respective cameras to control circuitry for and otherwise with respect to encoded symbology reader assembly 24. Each camera also includes a lens assembly 106 consisting of a “C” mount, an extension 108 which in this embodiment is selected to be 5.5 mm, and an 8.5 mm lens 109 with locking screws (not shown). Other lens assembly arrangements may also be selected depending upon the positioning of camera assemblies (80-86) and the target image to be captured.

Camera support bracket assemblies 90, 92, 94 and 96 respectively are each substantially identical in construction and operation so only one such assembly, camera support bracket 90 will be described in detail. A body portion 110 (FIGS. 6 and 8) of camera support bracket 90 includes a pair of spaced arms 112 extending outwardly therefrom. An opening 114 (FIGS. 8 and 9) formed through body portion 110 receives a conventional ball joint assembly 116 including ball joint bearings (not shown). Ball joint standoffs 118 interconnect body portions 110 of each camera support bracket assembly 90, 92, 94 and 96 to base plate 78. Each body portion 110 also includes three openings 120 (FIGS. 4, 8 and 9) that receive threaded adjustment members (not shown) with each such adjustment member extending through its respective opening and into base plate 78. The underside 122 of each body portion 110 is formed with counterbores 124 surrounding each opening 120 sized and configured to receive an upper end of a spring 126 the other end of which rests upon base plate 78. Springs 126 are each positioned to surround a respective one of each such threaded adjustment members. The threaded adjustment members are rotated either clockwise or counter-clockwise to pivot respective camera support bracket assemblies (90-96) about their respective ball joint assemblies 116 and by doing so adjust the position of the cameras (80-86) carried thereby with respect to window 60 and a rack 30 of symbology encoded 38 vials 32 that may be disposed thereupon; all as will be explained in greater detail hereafter. Ball joint assemblies 116, their bearings and standoffs 118 function in a substantially conventional manner to facilitate pivoting and rocking movement of their respective camera assemblies (90, 92, 94 and 96) to position such camera assemblies in manners and for purposes to be hereinafter explained in further detail.

Suitable and appropriate attaching items, such as a threaded member 130 (FIGS. 4 and 9) is extended through each spaced hole (not shown) formed through each of the spaced arms 112 of each camera support bracket assembly (90-96). Each such threaded member 130 is then extended through a spacer 132 camera printed circuit board 102, spacer 104 and camera printed circuit board 100. A nut (not shown) is thereafter utilized to secure the above items in place. Each camera (80-86) is thus secured to its respective support bracket assembly (90-96) when all four threaded members 130 have been so utilized to connect camera circuit boards 100 and 104 to arms 112 of the support bracket assembly (90-96).

An “L” shaped locking bracket 140 (FIGS. 4, 5, and 9) is provided for cooperation with each camera support bracket assembly (90-96). Each bracket 140 is disposed proximate an outward side 142 of each body portion 110 of each camera support bracket assembly (90-96) as shown in FIGS. 4, 6 and 8. A pair of threaded members 144 are used to securely attach an outwardly extending leg 146 of each bracket 140 to base plate 78. An upwardly extending arm 148 of each such bracket 140 is disposed proximate outward side 142 of the respective cooperating camera support bracket assembly (90-96). An upwardly extending slot 150 is formed through each such arm 148 to receive a pin 152 that extends out from side 142 of each support bracket assembly for purposes to be hereinafter described. Locking bracket 30, through its disposition adjacent body portion 110, and due to the coaction of pin 152 and slot 150 permits camera bracket assembly (90-96) and its respective camera (80-86) to rotate about horizontal axis “x”, or “y” but prevents rotation about a vertical “z” axis.

Each camera 80, 82, 84 and 86 is positioned by its respective support bracket assembly 90, 92, 94 and 96 respectively for optimum and efficient capture of encoded symbology 38 carried by vials 32 when properly positioned and disposed on window 60. Such positioning of each of cameras 80, 82, 84 and 86 is individually accomplished by turning the threaded members (not shown), which extend through opening 120 of each camera support bracket assembly body 110 and into base 78; in either a clockwise or counter-clockwise direction until the respective camera (80-86) is optimally positioned. Springs 126 function to facilitate such positioning. In this particular instance such threaded adjustment members for each camera support bracket assembly (90-96) are adjusted so that the support bracket assembly positions its respective camera (80-86) at an angle of substantially three degrees (3°) to the horizontal and so that adjacent pairs of cameras 80-84 and 86-88 are tilted towards each other (FIG. 7) when observed from a side of scanner 20 for reasons to be hereinafter described in greater detail.

Other adjusted positions for cameras 80-86 may be similarly accomplished depending upon the application and use for scanner 20.

If desired, a threaded blocking member (not shown) may be inserted into each opening 120 to limit access to respective adjustment members and/or to lock them in position after adjustment as described above.

The four camera assemblies (80-86) are positioned, as described above, so that each captures a particular area of the underside of array 34 of vials 32. More particularly camera assemblies (80-86) and provided with lens assemblies 106 and are so positioned so that each camera captures at least one quarter of the encoded symbology 38 carried vials 32 of array 34.

Other image capture arrangements may be provided depending upon the number, size, disposition, and other characteristics of the articles in an array of articles, the kind and disposition of the encoded symbology carried by such articles and the disposition of the other scanner components. The number of camera assemblies may also be varied with either more or less then four such camera assemblies utilized and with a corresponding number and disposition of camera support and positioning mechanisms. When less then four camera assemblies are so utilized, especially if only a single camera assembly is to be so employed, higher resolution camera assemblies may be required. The number and disposition of encoded symbologies 38 to be imaged by each such camera assembly as well as thye array arrangement will, of course, depend upon the number of such camera assemblies.

An illumination assembly 180 (FIGS. 8 and 9) is provided for scanner 20. Four printed circuit board mounting blocks 182, 184,186 and 188 respectively secure a pair of long illumination printed circuit boards 190,192 and a pair of short illumination printed circuit boards 194,196 into a substantially rectangular configuration as shown in FIGS. 8 and 9. A threaded member 200 (FIGS. 5, 8 and 9) is utilized to connect each mounting block 182-186 to the underside of support plate 64 as shown in FIGS. 4, 6 and 7; and to position illumination assembly 180 with respect to the underside of window 60, and any encoded symbology 38 carried by vials 32 that may be positioned thereupon, as well as with respect to cameras 80-86.

Each long illumination printed circuit board 190,192 and each short illumination circuit board 194, 196 carries and positions a number of red, 636 nm LED's 210 and is selected to provide non-diffused, low angle, “dark field” illumination. LED's 210 are arranged horizontally but may be angled upward toward and under window 60.

A substantially “L” shaped back plate 216 (FIGS. 4-9) is secured to base plate 78 by threaded members or the like. A regulator printed circuit board 218 and a component printed circuit board 220 are each appropriately secured to a leg 222, 224 respectively of back plate 216.

An opening 230 (FIG. 4) is formed through base plate 78 to facilitate access to components within scanner 20 to facilitate servicing same. A cover plate 232 (FIG. 6) secured in place by threaded members 234 is utilized to close opening 230 when access into scanner 20 is not required. A set of feet 240 (FIG. 6), suitably secured beneath base plate 78 may be utilized to raise scanner 20 above a surface that it may be resting upon.

It should be understood that while the components of scanner 20 have been shown and described as being disposed within housing 22 and accessible through opening 230 closed by cover plate 232 that neither housing 32 nor cover 232 need be provided if the components of scanner 20 are to be otherwise positioned and housed.

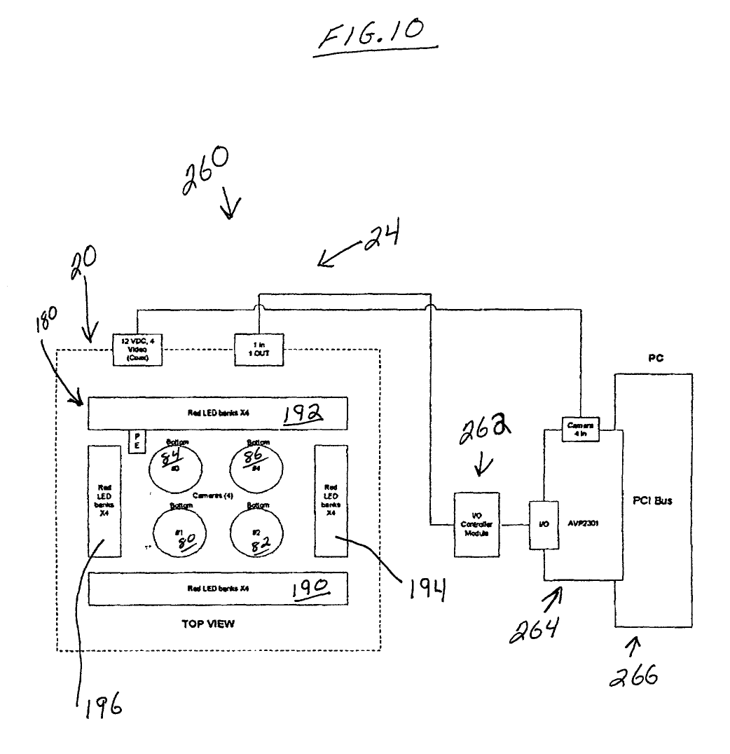

A photo-optical sensor 250 (FIGS. 4 and 5) is positioned on top of window retainer 62 to sense the presence, or absence, of a rack 30 of vials 32 on window 60. Suitable and appropriate electrical conductors and components connect sensor 250 to the control circuitry of FIG. 10.

A simplified control circuit assembly 260 for encoded symbology reader 24 is shown in FIG. 10. Camera assemblies 80, 82, 84 and 86 are symbolically shown disposed for coaction with illumination assembly 180 for scanner 20. Suitable and appropriate electrically conductive cabling 262 interconnects scanner 20 with an I/O controller module of conventional construction; while other suitable and appropriate cabling interconnects scanner 20 with a machine vision processor board 264 for a computer 266, which may be of the personal computer type. Panel 264 may be of a type sold by RVSI Acuity/CiMatrix under their designation AV2301.

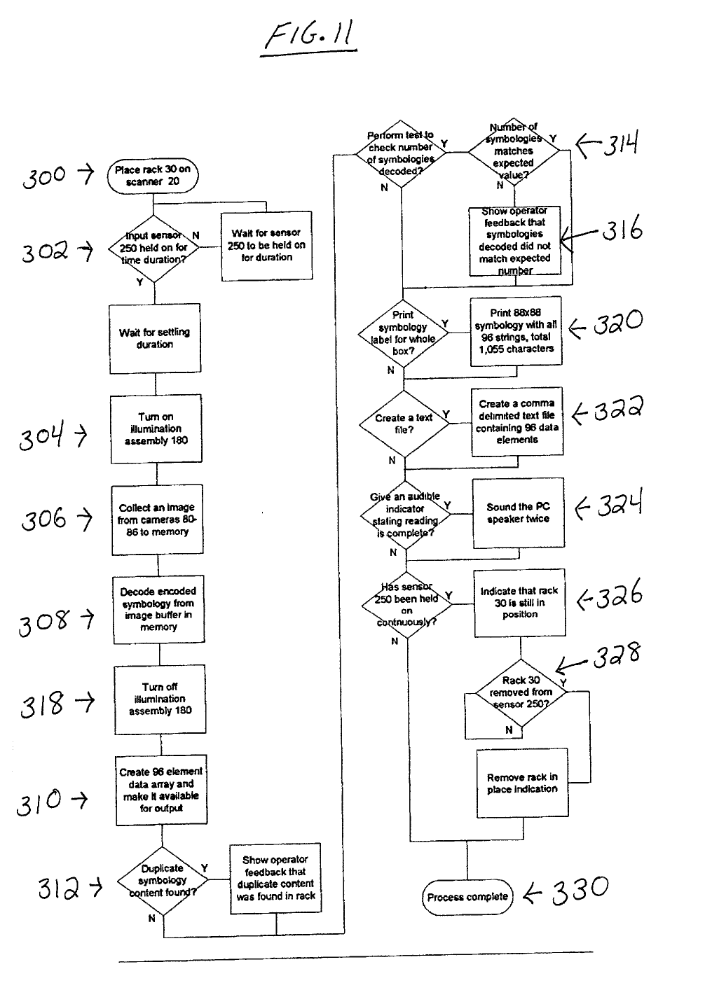

The operation of reader 24 and scanner 20 will be explained along with reference to the Flow Diagram of FIG. 11.

A rack 30 Of articles, such as vials 32 each carrying encoded symbology 38, such as a Data Matrix, is placed on window 60 at step 300. Sensor 250, coacting with rack 30 when so disposed, is held in its on position as long as rack 30 remains positioned as described for step 302. At step 304 illumination assembly 180 is energized for an alloted time, which could be strobbing, while at step 306 camera assemblies 80-86 are activated each to image one quarter of the array of the encoded symbology 38 carried by vials 32. The images may overlap a predetermined amount to facilitate proper image capture.

At steps 308 and 310 the images are respectively decoded and a data array corresponding to the number of encoded articles, in this instance 96, is made available for output. The combined images captured by cameras 8-86 may also be displayed on a monitor as shown in FIG. 12 as well as other desired displays.

At steps 312 and 314 any duplicate encoded symbology content, if found, are shown to the operator and checking is done for the number of encoded symbologies to decode, respectively. If the number of encoded symblogies decoded does not match the expected number that is shown to the operator at step 316. After the number of encoded symbologies are found to correspond to the number expected to be found the decode is considered to have been sucessfully accomplished and illumination assembly 180 is turned off a step 318.

At step 320 an encoded symbology label, not shown, if desired (which may include an 88×88 Data Matrix encoded symbology with, for example, 96 strings an a total of 1,055 characters) may be printed for application to cover 44 of rack 30. A comma delimited text file for the number of encoded symbology articles (in this example 96), if desired may be created at step 322. In addition and also if desired an PC speakers may be sounded to provide an audible indicator that reading is complete at step 324 and at step 326 an indication is provided that sensor 250 has been held on continuousely.

At this juncture rack 30 may be removed (at step 328) and an indication is provided that rack 30 has been in place is removed. The process is now considered to be complete at step 330.

The encoded symbology may be used to identify each article as it is recorded in a data base so that different proceedures for different articles may be performed via a data base lookup. The encoded symbology as provided and utilized as herein above described insures that regardless of the position in the array, rack, carrier or the like, of the article (vial 32) that the proceedure information (test data) that is recorded for the respective article will be properly associated with that article. The particular proceedure to be performed for any particular may alsso be encoded in the encoded symbology so that a data base lookup is not required.

From the above description it will thus be seen that there has been described new and novel apparatus and methods for handling a plurality of symbology encoded articles for proceedures to be employed with respect to each individual article to insure accuracy in associating the required proceedure with the article for that specific proceedure.

Numerous alterations of the structure, components, controls and process herein disclosed will suggest themselves to those skilled in the art. However, it is to be understood that the present disclosure relates to the preferred embodiments of the invention, which is for pruposes of illustration only, and not to be considered as a limitation of the invention. All modifications, which do not depart from the spirit of the invention, are intended to be included withinthe scope of the appended claims.

What is claimed is:

1. An encoded symbology scanner for simultaneousely scanning encoded symbology from a number of articles upon which symbology has been encoded, comprising;
(a) support means for the scanner for receiving one or more articles upon which symbology has been encoded;
(b) illumination means disposed to simultaneously illuminate all of the encoded symbology carried by all articles that are together upon said support means;
(c) imageing means disposed to simultaneously image all of the encoded symbology when received together by said support means; and
(d) decoding means for decoding the encoded symbology images.

2. The encoded symbology scanner of claim 1 wherein;
(a) said support means includes transparent window means disposed to simultaneously receive a plurality of symbology encoded articles so that the encoded symbology may be disposed upon said window means and for illumination by said illumination means; and
(b) said imaging means includes a CCD camera means disposed and lensed to simultaneousely capture an image of all of the encoded symbology.

3. The encoded symbology scanner of claim 2 wherein;
(a) said imaging means includes a plurality of said CCD camera means simultaneously operated but with each said CCD camera means disposed to capture only a portion of the encoded symbology;
(b) said decoding means functioning to decode the symbology for each of said portions and to assemble the so decoded symbology into a stream of decoded data.

4. The encoded symbology scanner of claim 3 wherein; there are four CCD camera means each disposed to capture a quarter of the encoded symbology.

5. The encoded symbology scanner of claim 4 wherein; the encoded symbology is different for each article with encoded symbology.

6. The encoded symbology scanner of claim 5 wherein; the articles to be encoded are test tubes or vials disposed in a predetermined array in a rack means.

7. An encoded symbology scanner for simultaneousely scanning encoded symbology from a number of articles upon which symbol ogy has been encoded, comprising;
(a) a support for the scanner for receiving one or more articles upon which symbology has been encoded;
(b) an illumination assembly disposed to simultaneously illuminate all of the encoded symbology carried by all articles that are together upon said support;
(c) an mageing device disposed to simultaneously image all of the encoded symbology when received together by said support; and
(d) a decoder for decoding the encoded symbology images.

8. The encoded symbology scanner of claim 7 wherein;
(a) said support includes a transparent window disposed to simultaneously receive a plurality of symbology encoded articles so that the encoded symbology may be disposed upon said window and for illumination by said illumination assembly; and
(b) said imaging device includes a CCD camera disposed and lensed to simultaneousely capture an image of all of the encoded symbology.

9. The encoded symbology scanner of claim 8 wherein;
(a) said imaging device includes a plurality of said CCD cameras simultaneously operated but with each said CCD camera disposed to capture only a portion of the encoded symbology;
(b) said decoder functioning to decode the symbology for each of said portions and to assemble the so decoded symbology into a stream of decoded data.

10. The encoded symbology scanner of claim 9 wherein; there are four CCD cameras each disposed to capture a quarter of the encoded symbology.

11. The encoded symbology scanner of claim 10 wherein; the encoded symbology is different for each article with encoded symbology.

12. The encoded symbology scanner of claim 11 wherein; the articles to be encoded are test tubes or vials disposed in a predetermined array in a rack.

13. A process for scanning encoded symbology from a number of articles upon which symbology has been encoded, comprising;
(a) positioning a plurality of articles upon which symbology has been encoded for simultaneous decoding;
(b) simultaneousely illuminating all of the encoded symbology for all of such articles;
(c) simultaneously imageing all of the encoded symbology so disposed; and
(d) decoding the encoded symbology images.

14. The symbology scanning process of claim 13 including;
(a) providing and disposing a transparent windor to simultaneously receive a plurality of symbology encoded articles; and
(b) simultaneously imaging means all of the encoded symbology for the articles with a CCD camera disposed and lensed to simultaneousely capture an image of all of the encoded symbology.

15. The symbology scanning process of claim 14 including;
(a) employing a plurality of said CCD cameras to simultaneously image the encoded symbology but with each said CCD cameras disposed to capture only a portion of the encoded symbology;
(b) decoding the symbology for each of said portions and assembling the so decoded symbology into a stream of decoded data.

16. The symbology scanning process of claim 15 wherein; there are four CCD cameras each disposed to capture a quarter of the encoded symbology.

17. The symbology scanning process of claim 16 wherein; the encoded symbology is different for each article with encoded symbology.

18. The symbology scann process of claim 5 wherein; the articles to be encoded are test tubes or vials and are disposed in a predetermined array in a rack.
